(19) United States
(12) Patent Application Publication
(10) Pub. No.: US 2008/0127711 A1
(43) Pub. Date: Jun. 5, 2008

(54) Force and Torque Measurements with Calibration and Auto Scale

(76) Inventor: TAREK A.Z. FARAG, St. Charles, IL (US)

Correspondence Address: TAREK FARAG, 33W135 BONNIE ST., ST. CHARLES, IL, 60174-5308, US

(21) Appl. No.: 11/566,550

(22) Filed: Dec. 4, 2006

(51) Int. Cl. G01L 25/00

(52) U.S. Cl. 73/1.11; 73/1.08

(57) ABSTRACT

This invention is device and method for electronic measurements of the force and torque applied to a work piece. The measured values are visually displayed, audibly indicated, and/or transferred in electronic formats to other controlling devices. The values could be displayed in different physical measuring units, and as an average or peak. The device produces different output signals when the torque applied equals or exceeds predetermined values. This device and method provide an automatic, accurate, and easy calibration, which could be self-calibration or in-the-field calibration. It has protection from accidental activation of the switches, and provides a permanent record of the incidents in which the device was operated at conditions beyond its specifications. It provides a manual and/or automatic scale selection to improve the accuracy.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to electronic measurements of force and torque (force multiplied by distance), which give an indication of the force or torque level applied to a work piece. The values measured could be visually displayed, audibly indicated, and/or transferred in electronic format to other controlling devices. The device can produce an output signal when the torque applied equals or exceeds a predetermined value. It relates to an automatic, accurate, and easy calibration, which could be self-calibration or in-the-field calibration, in addition to manual or automatic scale selection.

2. Description of the Prior Art

Force and torque measurements devices are well known for many years and many patents were issued for them. Torque measurement and controlling devices using mechanical or electrical methods are well known in the prior art. Some examples from U.S. Patents are: U.S. Pat. Nos. 2,074,079, 2,201,234, 2,250,941, 2,289,238, 2,553,311, 2,996,940, 3,596,543, 3,670,602, 3,726,135, 3,747,423, 3,970,155, 4,006,629, 4,073,187, 4,226,127, 4,257,263, 4,276,772, 4,488,442, 4,522,075, 4,541,313, 4,558,601, 4,562,746, 4,615,220, 4,641,538, 4,643,030, 4,669,319, 4,762,007, 4,791,839, 4,864,841, 4,958,541, 4,976,133, 4,982,612, 5,181,575, 5,228,527, 5,303,601, 5,400,663, 5,465,627, 5,520,059, 5,983,731, 6,070,506, 6,324,918, 6,386,052, 6,443,019, 6,796,190, 6,843,141, 6,889,584, 6,981,436, and 7,107,884. The main disadvantages of the prior art methods are their accuracy and measurement methods. Generally the measurements were done using strain gauges or flexible mechanical members (like spring loaded lever) coupled to an electronic device. They are difficult to calibrate both in the field or the factory, especially after normal or abnormal use, and at different operating conditions of temperature, humidity, dust, etc. In the cases of impact wrenches, the error could be very high due to the variation of the inertia and the holding method (holding the tool firmly or loosely will change the impact force on the workpiece). Also, the indicated reading could be confused between an average and a peak value. Other disadvantages are the large size of the sensors and the large inertia, which limit their response time and the applications.

Another disadvantage of the prior art is that there were no means to record or prove that the user abused the tool if the tool was damaged due to exceeding its design limits. This made the tools manufacturers “over design” their tools, to be able to handle the abuse, which increased the cost.

Another disadvantage of the prior art is that the user has no choices in displaying the value (peak, average), and most of them do not have the ability to measure the torque required to loosen a part. When loosening a tightened nut, it is important (in the cases where the tightening specification is not available) to know what was the tightening torque.

### OBJECTS OF THE INVENTION

Accordingly, several objects and advantages of my invention are:
(a) to provide a device and a method to measure and display the force or the torque applied to a workpiece, which will have the advantages of: low cost, high reliability, long life, fast response, small size, high accuracy, easy to set, flexible to attach to other devices, and could be calibrated easily at single or multiple points in the field or the factory at all operating conditions;
(b) to provide a device which will have the advantages as mentioned in (a) and could measure the peak or average torque within very small time intervals, independently of the position or the angle at which the force is applied;
(c) to provide a device which will have the advantages as mentioned in (b) and could generate different signals (audio, visual, disconnect, electrical, vibration, etc.) when the torque applied to the workpiece is less than, equal to, or higher than, the preset value;
(d) to provide an economical device to turn a workpiece (e.g. nut or bolt) continuously in one direction or the other, at different torques, quickly in a convenient way;
(e) to provide a device which will have the advantages as mentioned in (c) and (d), and could be provided with power drive (air, electrical, manual, or mechanical) to increase its speed and effectiveness; and
(f) to provide a device which will have the advantages as mentioned in (e) and could communicate and interface with other devices to make them control it (set it up) or it can control the other devices.

Other objects and advantages of the device are: display the torque measurements in different physical units; has manual and/or automatic scale selection to improve the accuracy; save the time and effort and do the work safely and accurately; has a Low profile to fit in tight areas; could be manufactured in different forms (screw-driver, wrench, clutch, drill, etc.); display the torque value plus audible announcement; generate audible signal to indicate how close the torque to the set value; protection from exceeding the limit of the wrench or the set value; capable of recording the incidents in which the torque exceeded the allowable limits; remote reading and setting for the torque value using serial communication on a wire or wireless connection (like when used with a robotic arm or on production lines to avoid the possibility of the operator error); customization for individual needs for each customer (examples include storing limited number of stored torques to be called on doing certain jobs, and locking certain torque values to prevent the operator from accidentally changing them).

Still further objects and advantages will become apparent from a consideration of the ensuing description and drawings.

### DRAWINGS FIGURES

FIG. 1 shows a polymer-film force sensor.

FIG. 1a shows a force sensor connected in a multi-scale configuration.

FIG. 2 shows an electronic force measurement using a spring and a displacement sensor.

FIG. 3 shows an electronic force sensor with a springably lever structure.

FIG. 4 shows an electronic force sensor using hydraulic gain.

FIG. 5 shows an innovative electronic sensor to measure the displacement using a resistor.

FIG. 5a shows the equivalent electrical circuit of the sensor of FIG. 5.

FIG. 5b shows another electronic sensor to measure the displacement using a resistor.

FIG. 5c shows the equivalent electrical circuit of the sensor of FIG. 5b.

FIG. 6 shows an electronic sensor to measure the displacement using light.

FIG. 7 shows an electronic sensor to measure the displacement using magnetism.

FIG. 8 shows an electronic multi-tool torque-measuring attachment.

FIG. 8a shows a side view of a method to hold a ratchet wrench on the attachment of FIG. 8.

FIG. 8b shows a plan view with partial cut of a method to hold a ratchet wrench on the attachment of FIG. 8.

FIG. 8c shows a side view for FIG. 8b, of a method to hold a large wrench on an electronic torque measuring attachment like the one shown in FIG. 8.

FIG. 8d shows a view of the method to hold a large wrench shown in FIG. 8c.

FIG. 8e shows two enclosed channels to hold a wrench on an electronic torque measuring attachment like the one shown in FIG. 8.

FIG. 8f shows two different U-shaped channels to hold a wrench on an electronic torque measuring attachment like the one shown in FIG. 8.

FIG. 9 shows details of a torque measurement method.

FIG. 10 shows a foldable torque calibration tool.

FIG. 10a shows a torque calibration tool with one adjustable wrench holder.

FIG. 11 shows a method for measuring the torque in two directions using a potentiometer.

FIG. 11a shows a wrench like the one in FIG. 11 with additional displacement magnification.

FIG. 12 shows a power air wrench with electronic torque measurement.

FIG. 13 shows a swivel head wrench with electronic torque measurement.

FIG. 13a shows the head of the wrench of FIG. 13 with an angle compensation sensor.

FIG. 13b shows angle compensation with an output signal proportional to the cosine of the angle in a zero angle (straight) position.

FIG. 13c shows angle compensation with an output signal proportional to the cosine of the angle in a non-zero angle position.

FIG. 14 shows an electronic torque measuring method for a power wrench.

FIG. 14a shows details of FIG. 13 for measuring the torque in two directions.

FIG. 15 shows a power electrical wrench with infinite ratcheting and electronic-torque.

FIG. 16 shows an electromagnetic clutch with electronic torque measurement.

FIG. 16a shows a side view of FIG. 10, with sectional view showing the torque sensor.

FIG. 16b shows a detailed sectional view of the bi-directional torque sensor.

FIG. 17 shows a general block diagram of the electronic torque wrench.

(NOTE: All the drawing figures are simplified and not to scale).

DRAWINGS REFERENCE NUMERALS

| | | | | | |
|---|---|---|---|---|---|
| 35 | Pawl arm | 36 | Holding nut | 37 | Holding bracket |
| 38 | Ratchet wrench | 39 | Force sensor | 40 | Incrementing switch |
| 41 | Units toggle switch | 42 | Measuring board | 43 | Decrementing switch |
| 44 | Digital display | 45 | Calibration switch | 46 | Torque attachment |
| 47 | Handle | 48 | Open wrench | 49 | L-Shaped adaptor |
| 50 | Elliptical adaptor | 51 | Two pieces adaptor | 52 | U-Shaped adaptor |
| 53 | J-Shaped adaptor | 54 | Urging pin | 55 | Urging pin spring |
| 56 | Sensor lever | 57 | Pivot | 58 | Resistor wiper contact |
| 59 | Resistor (as sensor) | 60 | Positioning groove | 61 | Mounting screw |
| 62 | Sensor spring | 69 | Pivoting wedge | 70 | Lever |
| 71 | Displacement arm | 72 | Displacement sensor | 73 | Flexible lever |
| 74 | Levered spring | 75 | Curved contact strip | 76 | Strip spring |
| 77 | Protector | 78 | Insulating body | 79 | Light emitter (LED) |
| 80 | Light aperture | 81 | Photo sensor | 82 | Magnet |
| 83 | Magnetic sensor | 84 | Ratcheting reversal | 85 | Body pivot |
| 86 | External body | 87 | On/Off control | 88 | Air supply hose |
| 89 | CW switch | 90 | Electronic board | 91 | Reduction gears |
| 92 | Electric motor | 93 | Battery | 94 | CCW switch |
| 95 | Worm gear | 98 | Worm gear helix | 99 | Worm gear shaft |
| 100 | Power wrench body | 101 | Force sensor position | 102 | Alternate sensor position |
| 103 | Second press pin | 104 | First press pin | 105 | Power wrench |
| 106 | Force sensor mounting | 126 | Driven shaft | 127 | Driven head |
| 128 | Clutch assembly | 129 | Sensor assembly | 130 | Drive head |
| 131 | Drive shaft | 170 | Piston shaft | 171 | Piston |
| 172 | Piston cylinder | 180 | Square driving shank | 194 | Pivoted ratchet head |
| 195 | Angle measuring resistor | 196 | Resistor wiper | 197 | Calibrated weight |
| 198 | Calibration notches | 199 | Foldable arm | 200 | Arm support |
| 201 | First calibration arm | 202 | Large calibration hole | 203 | Small calibration hole |
| 204 | Medium calibration hole | 205 | Main switch | 206 | Power supply |
| 207 | Serial port | 208 | USB port | 209 | Wireless port |
| 210 | Input device (Key-bad) | 211 | External memory | 212 | Input/output bus |
| 213 | Motor on/off control | 214 | Direction switch | 215 | Main torque sensor |
| 216 | Conditioning circuit | 217 | Auxiliary sensor | 218 | Auxiliary conditioning |
| 219 | Angle sensor | 220 | Angle conditioning | 221 | Audible output device |
| 222 | Interface bus | 223 | Processor (microcontroller) | 224 | Clamping jaw |
| 225 | Clamping screw | 226 | Adjustable driver hole | 227 | Magnifying arm |
| 228 | Magnifying pivot | 229 | Ratchet arm | 230 | Swivel head pin |
| 231 | Swivel fixed pin | 232 | Slide | 233 | Audio conditioning |
| 234 | Angle mark on head | 235 | Zero angle mark | 236 | +90 deg. angle mark |
| 237 | −90 deg. angle mark | 238 | Temperature sensor | 239 | Hydraulic fluid |
| 240 | Gas (air) | 241 | Pressure shell | 242 | Pressurized casing |

### ABBREVIATIONS, SYMBOLS, AND DRAWINGS REFERENCE LETTERS

A+ Increase value.
A− Decrease value.
Aux Auxiliary function.
a First electrical contact point.
b Second electrical contact point.
c Middle (wiper) electrical contact point.
D Direction of rotation signal.
F Force.
F/M Ft-Lb or Newton-Meter (English or Metric) conversion.
K Force constant (change of resistance for force change, N.KOhm or Lb.KOhm).
N Newton.
P Power on signal.
PD Power distribution.
R, Ro Fixed resistors.
Rs Sensor resistance.
S Signal generated when the torque is higher than the set torque value.
V+ Positive power supply.
V− Negative power supply (ground).
Vo Output voltage signal.

### DESCRIPTION OF THE INVENTION

The two measurements of force and torque could be exchanged, with the understanding that the torque is the amount generated when multiplying; the force component perpendicular to the line from the point it acts on to the point where the torque measurement is made, by the distance between these two points. In the following description of embodiments and figures of this invention, measuring the force at a specific distance could be used to express the torque.

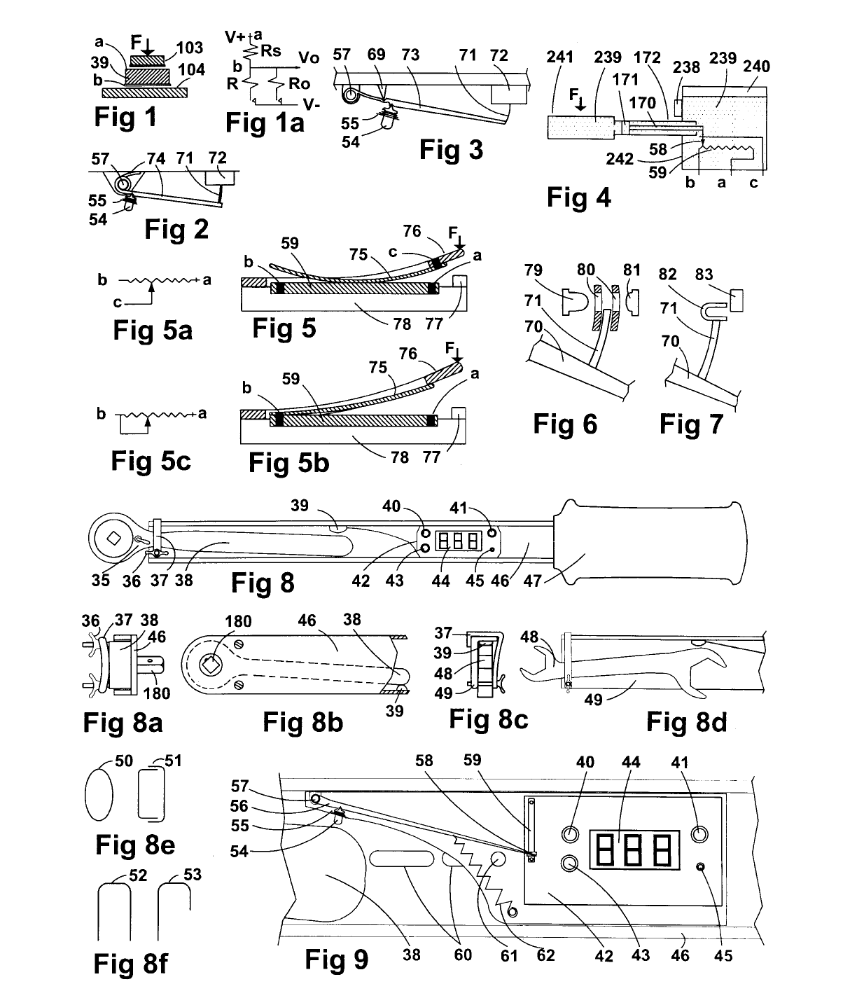

FIG. 1 shows a force sensor (39) with the force (F) applied on it. This sensor (39) is usually made from a polymer or elastomeric material, which has a resistance that changes proportional to the force applied on it. The resistance is measured between the first electrode (a) and the second electrode (b). This kind of sensor is best suited for this application because it has small dimensions (could be of a thickness less than 0.5 mm and a diameter less than 15.0 mm), easy to use, and is simple to condition electronically the variation of its resistance as a measurable output signal.

FIG. 1a shows a simple example of an electrical measuring circuit to get a signal (Vo) proportional to the force (F) using two resistors (R) and (Ro) that can be selectively connected to a common (V−) line using manual or electronic contact points. We can use electronic circuits with operational amplifiers with gain control, inside the microcontroller or on the board, to condition the signal of the sensor. In the simple configuration of FIG. 1a, the contact points could be input/output lines of the microcontroller. Each line can have different status: output low; output high; and input high impedance, which can give very large number of choices. To demonstrate the power of using the input/output lines of the microcontroller, consider an example where: the resistor (R) is permanently connected to ground, the resistor (Ro) is connected between the microcontroller and the point (b), and a small capacitor is connected between (b) and (V−) to keep the voltage and reduce the noise. The mentioned input/output line is used to read the sensor's voltage at (b) and also to control the scale. One scale is to have the line configured as input high impedance to read the voltage; in this case the resistor (Ro) has no effect on the reading. For a second scale the line will be configured as an output high; in this case the resistor (Ro) is in parallel with (Rs), and when reading the voltage the line will be input high impedance. A third scale the line will be configured as an output low; in this case the resistor (Ro) is in parallel to (R), and when reading the voltage it will be input high impedance. In the cases of auto-scaling, when the microcontroller reads a value of (Vo) out of a specified range, it will change the status of the line to bring (Vo) back within a required range, and compensate in each case for the changes in the electronic circuits.

Typically the relationship between the force (1/F) and the sensor resistance (Rs) is linear and can be expressed as:

Rs=K (1/F), where K is a constant (typically 50 to 500 N.KOhm).

Values of K for different physical units (e.g. Ft-Lb, Ft-in, and N-M) are stored in the microcontroller to perform the calculations according to the chosen units. By measuring the value (Vo) we can calculate the force from the equation:

F=(VoK)/(R(V+−Vo))

FIG. 2 shows a force measurement using a levered spring (74) pivoted around a pivot (57) to convert the force applied at the urging pin (54) to a displacement proportional to the force at the displacement arm (71). The displacement arm (71) acts on the displacement sensor (72) to generate an electrical signal proportional to the displacement, which will be proportional to the force. The displacement sensor (72) could be: a simple potentiometer with its wiper contact connected to the arm (71), or other sensing system as will be discussed later. An urging pin spring (55) is used to keep the pin (54) in contact with the correct point (a notch) on the lever part of the levered spring (74). The position of the urging pin (54) is set according to the required enlargement of the displacement at the displacement sensor (72), and the rigidity of the spring.

FIG. 3 shows a force sensing system similar to FIG. 1, but instead of having a spring, the rigidity of the flexible lever (73) is used to give the spring action. Also a pivoting wedge (69) is used to set the required enlargement of the displacement at the sensor (72).

FIG. 4 shows an electronic force sensor using hydraulic gain. The sensor has a pressure shell (241) and a casing (242) all filled with hydraulic fluid (239) and the casing (242) has a small volume of air (gas) (240) to act as a spring. The shell (241) and the casing (242) are connected by a piston cylinder (172), which has a piston (171) and a piston shaft (170). A potentiometer (59) has its contact point (58) mechanically connected to the shaft (170) but electrically isolated. The point (58) has electrical contact with the resistance element (59) and the contact line (c). The hydraulic fluid used should have electrical insulation with lubricating action without electrochemical reactions, which are available in many inexpensive oils. Also, air could be used as a hydraulic fluid. Applying a force F on the surface of the shell (241), will squeeze a volume of the hydraulic fluid proportional to the force F out into the cylinder (172), this will push the piston (171), and displace the shaft (170) with the contact point (58), a distance proportional to the force F, which generates a change of resistance between (b) and (c) proportional to the force F. As the pressure and volume of the gas (240) is dependant on the temperature, a temperature sensor (238) is added for compensation. We can get high gain for the piston displacement, by selecting a large area for the force-surface of the shell (241), and a small cross sectional area for the piston (171). This design has many advantages and could be implemented in different ways. The shell (241) could be of a small height (3 mm.) to fit in tight positions, and reasonable diameter (16 mm.), while the piston diameter to be small (2 mm.) to give large gain (about 64). The shell (241) could be away from the casing (242) and connected by a small tube, to allow flexibility of installation when there are space restrictions. Also, the elasticity of the casing (242) and the connections to the shell, can give a compression action (spring action) to do the function of the air volume (240). Instead of using a potentiometer to sense the displacement, the piston shaft could be made from magnetic material (or have a magnet) and use magnetic methods for detection. The casing (242) with its spring action could be replaced by spring acting on the piston shaft (170) to determine its displacement according to the force F.

FIG. 5 shows a force sensor using a resistor (59), a curved contact strip (75), and a strip spring (76). The drawings show a strip spring (76), but any other spring arrangement could be used. FIG. 5a shows the equivalent electrical circuit of the sensor of FIG. 5. When a force F is applied, it will displace the contact point (c) away from the terminal (b), increasing the resistance between (c) and (b) and decreasing the resistance between (c) and (a), in proportion to the force F. FIG. 5b shows another force sensor like the one in FIG. 5, except that the two points (c) and (b) are connected together, as shown in the equivalent electrical circuit of FIG. 5c. A protector (77) is added to these sensors to protect the resistor element and the sensor from excessive forces. The design of FIG. 5 has the advantages of: no moving wiper contact (that can wear the resistive element), magnification of the motion at the force point to the motion at the contact point, the force of contact is very small compared to the applied force F, very simple and inexpensive structure, low inertia, and low profile structure.

FIG. 6 shows an electronic force sensor using light. It has an LED (79) as the light source, an aperture (80), a light sensor (81), and a displacement arm (71). When a force is applied to the sensor, the arm (71) will move a distance (in proportion to the force) decreasing the amount of light passing through the aperture (80), reducing the amount of light received by the sensor (81) (in proportion to the distance and hence to the force). The light signal generated by the sensor (81) will be read, displayed, processed, etc. by the Microcontroller. To get an accurate reading, the light source (LED) has to be driven by an accurate constant current, and to save power this current should be pulsed.

FIG. 7 shows an electronic force sensor using magnetism. It has a (small) magnet (82) as the magnetic field source, a magnetic sensor (83), and a displacement arm (71). When a force is applied to the sensor, the arm (71) will move a distance (in proportion to the force) changing the magnetic field received by the sensor (83) (in proportion to the distance and hence to the force). The magnetic signal generated by the sensor (83) will be read, displayed, processed, etc. by the microcontroller.

A preferred embodiment of a universal electronic torque measuring attachment is illustrated in FIG. 8. It is possible to use it with many tools to do all the functions of the electronic torque device. As an example, FIG. 8 shows a regular hand ratchet wrench attached. FIG. 8b shows a plan view with partial cut of a method to hold a ratchet wrench on the attachment of FIG. 8, while FIG. 8a shows a side view of FIG. 8b. In the embodiment of FIG. 8b, the handle (46) has a circular hole that accepts the square driver (180) to hold the ratchet wrench without lateral movements but can allow rotation within the hole. FIGS. 8c and 8d show other tools mounted on the attachment, and FIGS. 8e and 8f show different shapes for the attachment adaptor (46). FIG. 8 shows the ratchet wrench mounted such that the sensor (39) is positioned where the force will be applied at the handle. The sensor (39) could be any suitable force sensor. The tool (ratchet wrench) should be secured to the adaptor (46) in a way to allow small amount of turning, with no change in the distance between the center of the tightened piece (nut) and the sensor (39). A method using a holding bracket (37) and a wing nut (36) is shown; other methods could be used like the two parts (51) of FIG. 8e. The measuring board (42) has: the sensor (39), a digital numerical display (44), an incrementing switch (40), a decrementing switch (43), a toggle switch (41) to select different physical units of the torque measurements, a calibration switch (45), and other electronic components (not shown in the drawings). The calibration switch is protected from accidental touching, which is done by having a small access hole to it. The device with all its components is calibrated as one unit in simple steps as explained later.

FIG. 9 shows details of a torque measurement method using a variation of the methods shown in FIGS. 2 and 3. The sensor comprises: a lever (56), pivoted at the pivot (57); an urging pin (54) acting on the lever to transfer the force from the tool (38) to the lever (56); a spring (62) that displaces the tip of the lever (56) in proportion to the force F; and a potentiometer (59) that has a sliding contact point (58) which is controlled by the tip of the lever (56). Due to self calibration capability, the contact point (58) is not required to have zero resistance at zero force, to allow for the installation error. The unit has holes in the form of channels (60), and screws (61), to allow the sensor to be moved inside the channels, then affixed with the screws at the best contact point with the tool (38).

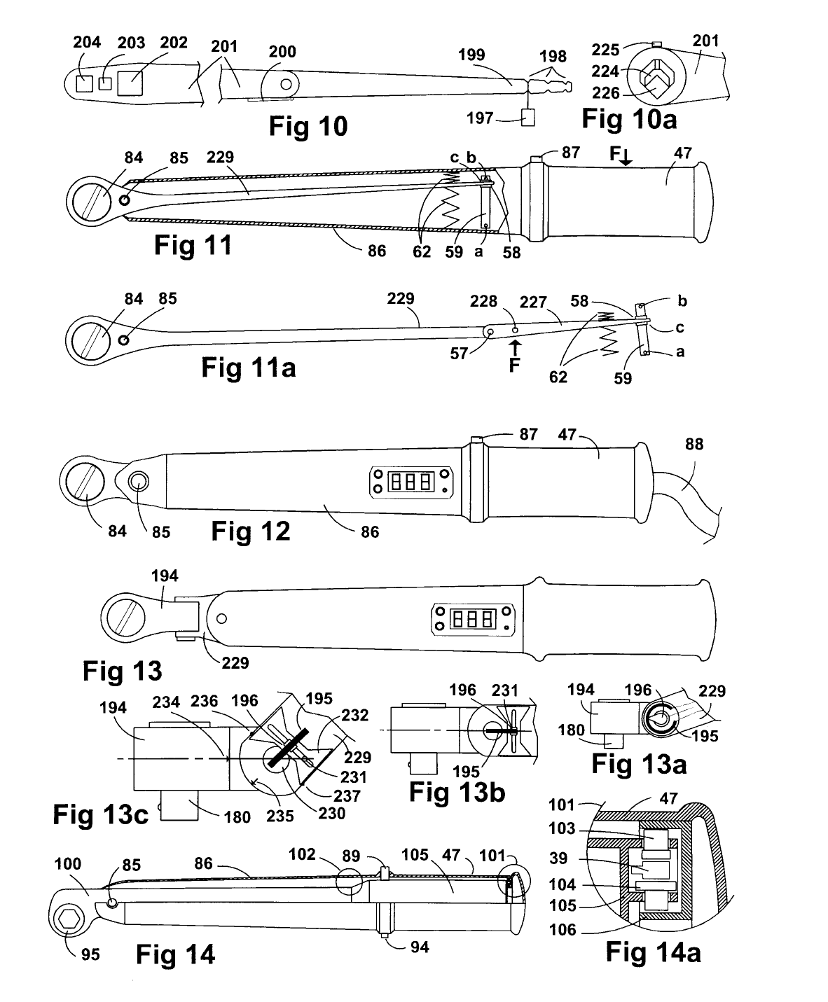

FIG. 10 shows a foldable torque calibration tool. It comprises a first arm (201) and a foldable second arm (199). The first arm has three driver holes: (202) for ½ inch driver, (203) for ¼ inch driver, and (204) for ⅜ inch wrench driver. The second arm (199) has three notches or marks (198) to hang the calibration weight (197); each corresponds to one of the driver holes. The torque due to the weight of the calibration tool without the weight (197) could be used for calibration. Also other known weight (197) can generate a known torque by hanging it at the corresponding notch (198) and to be added to the torque of the tool. Although the drawings show a two-part calibration tool, it could be made from one solid piece, or many foldable or telescopic pieces.

FIG. 10a shows a torque calibration tool with one adjustable driver hole (226) instead of the three holes (202, 203, and 204). A screw (225) is connected to a clamping jaw (224). The screw (225) is used to tighten the jaw (224) on the tool (wrench) driver, to be able to calibrate different sizes and shapes (hexagonal or square) torque wrenches.

FIG. 11 shows an electronic torque wrench that measures the torque in two directions using a potentiometer. It is similar to the method shown in FIG. 8, with the ratchet wrench a permanent part of the device. At zero torque the ratchet arm (229) should put the potentiometer wiper contact (58) close to the center of the potentiometer (59). An advantage of the self-calibration feature is that the contact (58) could be off-center. The force generated on the wrench arm (229) is applied by the spring (62), which will react to the force applied on the handle (47). As the spring (62) will expand or contract a distance proportional to the force applied on the spring, the slide (58) will be displaced in proportion to the force. This displacement will generate a change in the resistance between the point (c) and both the points (a) and (b), which could be detected by the electronic circuits and measured as torque.

FIG. 11a shows a wrench like that of FIG. 11 with additional displacement magnification. Instead of having the wrench arm (229) move the wiper point (58) directly, a magnifying lever (227) is added which will increase the displacement and reduce the force applied on the spring (62). A magnifying pivot (228) is attached to the handle (47) applies the force F on the magnifying lever (227), which will apply a much smaller force on the spring (62) and a force close to F at the pivot (57). Since a smaller force will be generated at the spring (62) a smaller spring could be used. The spring (62) is preferred to be one piece.

Another embodiment of the torque device is shown in FIG. 12, for a power air wrench with electronic torque measurement. In this embodiment the sensor will measure the applied force or the reaction force from the workpiece. It works very similar to the embodiment of FIG. 8. The holding bracket (37) is substituted by a pivot (85), and a main air on/off control (87) is added in series with an electrical on/off air valve to stop the flow of air when the torque reaches or exceeds a preset value. In the case of measuring the peak value of the torque in an impact air wrench, the value of the torque should be sampled at maximum speed during a specified time interval (e.g. 500 readings in 0.5 sec.) then store and display the largest value (the peak value within the 500 readings). Also the maximum of the peaks within certain time period (e.g. 3 sec.) could be used to update the stored and the displayed values. Also a momentary reset signal could be generated (e.g. by the decrementing switch (43)) to start a new set of measurements.

FIG. 13 shows a swivel head wrench with electronic torque measurement with head angle compensation. The embodiment of FIG. 13 is similar to that of FIG. 12 with the addition of the head angle compensation. A head compensation system could be any one that can generate a signal proportional to the angle. A drawing of a compensation method for the head angle is shown in FIG. 13a, which has a potentiometer (195) with a wiper contact (196). The wiper contact (196) [or the resistor (195)] is attached to the swivel head (194), and the potentiometer (195) [or the wiper (196)] is attached to the wrench arm (229). When the angle of the head (194) changes relative to the arm (229), the wiper (196) will change its angle on the potentiometer (195), which will change the resistance (or the voltage) measured at the wiper (196) in proportion to the angle. The microcontroller will correct the torque by multiplying the read value by the cosine of the angle. Another compensation method that gives an output directly proportional to the cosine of the angle between the head (194) and the arm (229) is shown in FIG. 13b and FIG. 13c. A straight potentiometer resistor (195) is used instead of the curved resistor used before in FIG. 13a. A swivel fixed pin (231) is attached to the head (194), which engages to a channel in the slide (232). The slide (232) moves parallel to the axis of the arm (229), and carries a wiper contact (196), which can slide on the resistor (195) and inside the channel of the slide (232). The resistor (195) is fixed to the arm (229). When the angle of the head (194) is turned relative to the arm (229), the swivel pin (231) will turn moving the slide (232), which will move the wiper (196) relative to the potentiometer (195), which will change the resistance measured at the wiper (196) in proportion to the cosine of the angle. This measurement will eliminate the need to make the cosine calculations by the microcontroller.

FIG. 14 shows an embodiment of an electronic torque measuring method for a power wrench. In this embodiment the power wrench (105) with its power drive (100) are enclosed in an external body (86), which has a handle (47). The force sensor (39) is mounted in a convenient location like (101) or (102). The location (101) is preferred because it gives longer leverage, which reduces the acting force on the sensor. FIG. 14a shows details of measuring the torque in two directions at the location (101). When a force is applied between the handle (47) and the wrench (105), the sensor (39) will be squeezed between the first press pin (104) and the second press pin (103), irrespective of the direction of the force. In these figures a sensor (39) similar to the one shown in FIG. 1 is preferred.

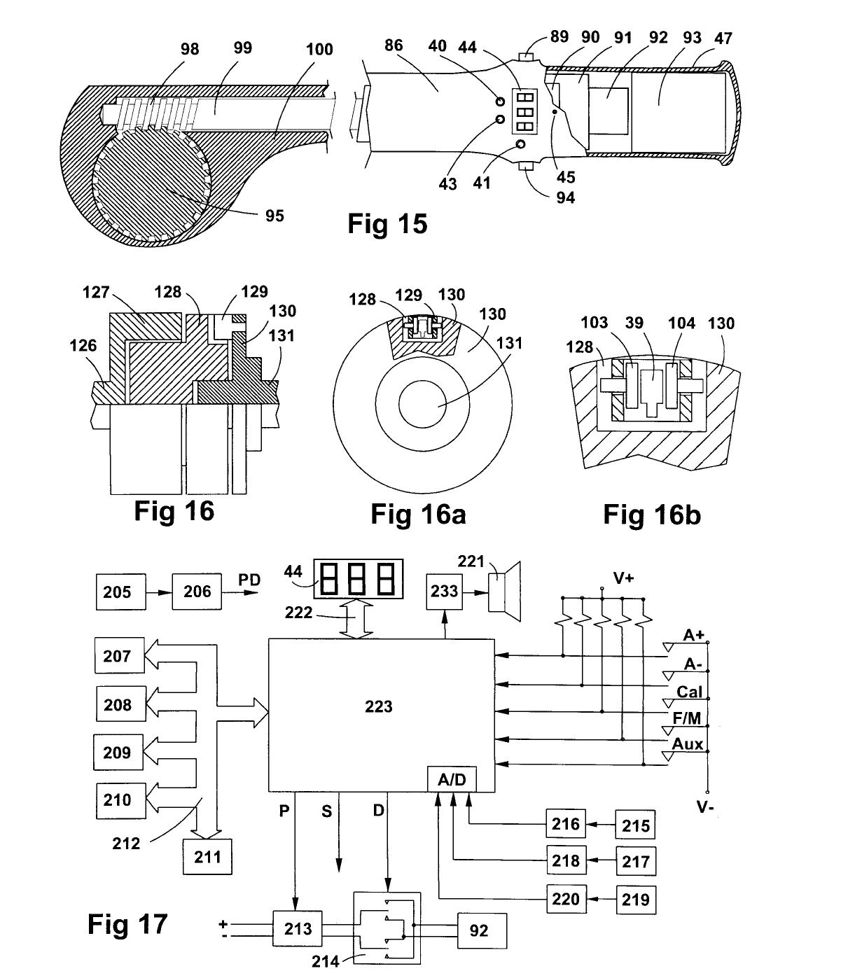

FIG. 15 shows a power cordless-electrical wrench with infinite ratcheting and electronic-torque. In addition to the electronic components to measure the torque, it has the following components: CW switch (89), CCW switch (94), battery (93), electric motor (92), reduction gears (91), worm gear shaft (99), worm gear helix (98), worm gear (95), and power wrench body (100). The worm gear (95) has a square driving shank (180) like the one shown in FIG. 13a, or a hex nut driver like the one shown in FIG. 14 (not shown in FIG. 15). The worm gear helix (98) and the worm gear (95) are designed in a way to prevent the gear (95) from turning the helix (98), to act as an infinite ratchet. The force sensor is not shown but it could be mounted at a location equivalent to the position (102) of FIG. 14, or at a flat surface at the end of the worm gear shaft (99) and perpendicular to its axis.

In the case of using the device to tighten the nuts or the screws to their final high torque, the motor (92), the reduction gears (91), and the electronic drives should be large enough to do the job. Operating this power wrench will be simple and requires only setting the torque value then pressing the CW switch (89), (or the CCW switch). By pressing the CW switch, the microcontroller will send a signal to connect the power from the power supply (battery) to the motor (92); which will turn the reduction gear (91); this will turn the worm gear shaft (99) turning the worm gear helix (98); which will turn the worm gear (95) in the CW direction until the torque reaches the set value, the microcontroller will stop the motor.

Another embodiment of the power wrench shown in FIG. 15, is based on the fact that the need for adjusting the torque is only at the final few turns, this wrench could be designed such that the motor with its gearing and drive be of substantially less size than the one described before. In this case the motor will tighten the screw (or nut) until before the final turns, then the operator will use manual power to tighten the screw. During the final tightening strokes, the torque will be higher than the capacity of the motor; the motor and the helix (98) will be stopped either by the microcontroller or the high torque; the worm gear (95) will be jammed by the (non-turning) helix (98). During the return stroke, the force and the torque on the worm gear (95) will be removed or reduced. This reduction in torque will be sensed by the microcontroller; which will activate the motor to tighten the screw (if the motor was not turning the screw will be loosened); this will keep a small torque on the screw until the operator starts another tightening stroke to reach the required torque. This embodiment will generate an infinite ratcheting action, with substantial reduction in size, cost, and power requirements.

FIG. 16 shows a simplified electromagnetic clutch with bi-directional electronic torque measurement. The clutch could be any kind that can engage and disengage in response to a signal generated by the torque-measuring device. FIG. 16a shows a side sectional view showing the torque sensor assembly (129). And FIG. 10b shows a detailed sectional view of the sensing assembly (129), in which the sensor (39) is pressed (squeezed) between the first press pin (104) and the second press pin (103), irrespective of the direction of the rotation as described in FIG. 14a. A drive shaft (131) and a drive head (130) are connected together (as one piece) are used to drive the clutch assembly (128) by the sensor assembly (129) to sense the force between them. A driven shaft (126) and a driven head (127) are connected together (as one piece) and used to drive the load by the clutch assembly (128). An electromagnet—part of the clutch assembly (128)—is constructed such that when an electrical current is applied to it, the clutch (128) will be engaged to the driven head (127) and will force it to turn with it. When the driven shaft (126) is driving a load, the sensor (39) will generate an electrical signal proportional to the torque, which will be processed by the microcontroller according to the preset program. When the torque value reaches or exceeds the preset maximum value, the torque device will generate the necessary signals to disengage the clutch assembly. Since in this type of applications, the torque device with the digital display could be revolving, it is more convenient to have a remote setup and display. One of the methods to do this is by having a wireless transceiver to communicate with a controller using serial communications.

This embodiment has many applications, few of them are: screwing bottle covers to a precise torque, measuring the power of a shaft by measuring the torque and the rpm, etc. In many applications, the embodiment of FIG. 16 without a clutch assembly could be used to tighten a workpiece to a specified torque, in the cases where the tool can be disengaged from the load (like robotic arm retracts after tightening the cover on a bottle).

FIG. 17 shows a block diagram of the electronic torque wrench in a general configuration with all the important features, it is self explanatory from the name and the function of each block. It comprises: a processing unit (microcontroller) (223) which has features enough to support the device functions (analog to digital conversion, static ram, permanent memory, pulse width modulation, serial communications, etc.); a main switch (205) to connect the power to the parts of the wrench; a power supply (206), e.g. battery, capable of giving enough power to all the parts; power distribution (pd); a serial port (207), a USB port (208), and a wireless port (209), all these ports to communicate with other devices like displays and programmers; an input device (210) like a key-bad; an external memory (211) to store extra data when the microcontroller does not have enough memory, like the codes for voice announcements; an input/output bus (212) to transfer data from/to the microcontroller; a motor on/off control (213) to activate a motor or other power device like an air valve; a direction switch (214) to change the direction of motor rotation or other power device; a main torque sensor (215); a conditioning circuit (216) to adapt the sensor signal to the microcontroller; an auxiliary sensor (217) like a distance measuring sensor or an air pressure sensor; an auxiliary conditioning circuit (218) for the auxiliary sensor (217); an angle sensor (219) to compensate for the angle between the handle and the wrench head; an angle conditioning circuit (220); an audio conditioning circuit (233) like a pulse width modulation circuit or digital to analog converter circuit; an audible output device (221) like a speaker or a buzzer; input/output signal lines (A+, A−, Cal, F/M, and Aux); and an interface bus (222) between the microcontroller and a display unit (44), the display could be a 7-segment numerical, alphanumeric, or other display.

A simplified embodiment of the general block diagram of FIG. 17 could be applied to the embodiment of FIG. 8. In this case the block diagram will be simplified to the following components: processor (223); main switch (205); battery power supply (206); power distribution (pd); main torque sensor (215) which is the sensor (39); conditioning circuit (216) which is the resistor R of FIG. 1; audio conditioning circuit (233) which is a low pass filter with amplification; audible output device (221) which is a speaker; input/output signal lines (A+, A−, Cal, and F/M); interface bus (222) which is the connections between the processor and the display unit (44); and the 7-segment numerical display unit (44).

### Setting Manually the Maximum Torque Value (e.g. to 34 Ft.Lb):

a. The operator will select the units (Ft-Lb) he wants (by toggling through the units).
b. Press the two buttons (A+) and (A−) on the same time for about 5 seconds. The processor (223) will verify this condition, then start flashing the display with the last set value or a default torque value; and activates the speaker (221) to announce the message “Set up” or to generate a buzzer sound.
c. The operator then releases the two buttons, then presses the button (A+) to increase or the button (A−) to decrease the value until the display reaches the required setting of 34 Ft.Lb. The speaker will keep announcing the set value every time it changes.
d. After about 5 seconds of no activity on the buttons, the display will show the 34 Ft.Lb value and the speaker will announce “End Set Up” then announces “Set value 34 Ft.Lb).
e. The display will show the value of the measured torque.

### Using the Wrench to Manually Tighten a Screw:

After setting the maximum torque as mentioned before, simply turn the wrench to tighten the screw. The device will display the current value of the torque and will announce it. In the cases where a buzzer is used instead of the speaker, the device will generate a signal at a frequency and/or a repetition rate proportional to the difference between the measured and the set values. When the torque reaches or exceeds the set value, an alarming audio signal will be generated and the display will flash.

### Audible Announcement of the Torque Value and Messages:

An audible announcement of messages is a good interaction method with the operator. It is suitable for different languages, and convenient when it is difficult to see the device display. One method to do this function is to generate a digital code for the possible announcements required, and store them organized in a permanent memory accessible to the processor (in the microcontroller permanent memory, or an external memory like (211)). In case of external memory, it is preferable to use a serial EEPROM because it is inexpensive and needs less input/output lines. To make the device pronounce the announcement, the microcontroller gets the digitized code of the voice and sends it to a digital to analog converter circuit (or to a pulse width modulation output line). The generated sound signal might need amplification to be able to drive the speaker, and a low pass filter to get rid of the undesirable high frequency components (the filtering might not be needed in case the speaker's response to high frequencies is very low). To demonstrate this by an example, let us assume that the device needs to announce “sixty seven Newton meter”. The microcontroller will get the corresponding digitized codes: “six”; “tee”; “seven”; and “Newton meter” from the memory and output them in the same sequence.

### Self-Calibration Function:

Although it is a simple function, it is a very powerful feature of this invention. The calibration could be done at multiple points, but most of the cases require one point in addition to the zero. The calibration is done by applying a known torque on the device and entering its value to the microcontroller, the device will run its own measurements, compare the measured value to the entered one and recalculate its parameters to get the best fit to meet the entered values, and then store the new parameters in its permanent memory.

There are two cases to consider, the first one is: when the unit has a known fixed structure, the output of the sensor is linear, and its weight generates a well-known torque when it is supported from the square driver (180). In this case this generated torque could be stored as a default calibration value in the permanent memory and used for calibration without other tools. Examples of these cases are the embodiments shown in FIGS. 11, 12, 13, 14, and 15. The second case is: when the unit does not have a known fixed structure, like the embodiments of FIG. 8 and FIG. 16. In this case, a tool like the one of FIG. 10 plus calibrated weights could be used for calibration.

The Self Calibration function will do the following steps to calibrate the device:
1. Get a large number of readings for the applied calibration torque.
2. Check the readings to validate the functionality of the sensor and the torque (a defective sensor or wrong calibration torque).
3. Calculate new parameters for the device as the calibrated parameters.
4. Store the calibrated parameters in the permanent memory for future calculations.
5. Repeat steps 1 to 4 for different calibration torques (weights), and for different directions [CW or CCW].
6. Display the result of the calibration process as “Er” for error, or “CL” for calibration, and announce the results by the speaker or the buzzer.

### Torque Calibration Steps:

### 1) An accurate torque is applied to the device (due to its weight or by a calibration tool).

### 2) The “Cal” switch is activated for about 3 seconds (to make sure that the switch was not touched accidentally).

### 2) The device will display “CL” and give announcement to indicate that it is ready for calibration, then display the value of the default torque for calibration.

### 3) The operator will press the A+ or A− buttons until the display shows the calibration torque to be used, then presses the calibration switch for about one second.

### 4) The device will wait for about two seconds (to avoid the vibration after the operator removes his hand), then runs its self calibration function.

### 5) The device will show the result of the calibration as “Er” in case of an error, or “CLd” if it was successfully calibrated and return to its normal condition and display the torque value, which should be the value of the applied calibration torque.

### Calibrating the Angle of the Arm:

In the cases where the device has a swivel head, it could have angle calibration marks at: zero, +90, and −90 degrees. Angle calibration could be done at zero torque and zero angle. During the zero calibration of the torque, the operator can keep the angle of the arm at zero, and the microcontroller will read its value as the calibration value. Another way to do the angle calibration is by swinging the head between +90 and −90 degrees. During this action the microcontroller will sample large number of readings, use the maximum value to indicate +90 degrees, average value for 0.0 degrees, and minimum value for −90 degrees. It should be noted that an error of 5 degrees at the zero location could cause an error of about 0.4%.

### Using a Power Torque Wrench to Tighten a Screw Semi-Automatically:

Let us assume that we have an electrical power torque wrench as shown in FIG. 15, with the wrench's maximum torque 100 Ft-Lb, and the maximum torque for the motor's drive at the work piece is 5 Ft-Lb. The screw needs to be tightened to 67 Ft-Lb. The first step is to set and lock the torque to 67 Ft-Lb. Then follow the following steps:
a. Press the CW switch, the motor will run turning the screw in the CW direction until its resistance reaches 5 Ft-Lb, the microcomputer will stop the motor.
b. While pressing the CW switch, apply the hand motion to turn the whole wrench CW to the maximum allowable swing to tighten the screw, then turn the whole wrench back CCW to its maximum backward swing as you normally do with a ratchet wrench.
c. During the backward swing the microprocessor will detect that the torque went below the 5 Ft-Lb and will immediately turn the motor to turn the screw in the CW direction preventing it from turning CCW during the backward swing. This will allow the rotation in one direction only (CW) like the ratcheting mechanism.
d. Repeat step b above and keep tightening until the torque reaches 67 Ft-Lb, at which the indicator will display 67 Ft-Lb, the alarm will sound (if the unit is provided with audible announcement the unit will announce the torque as 67). The microprocessor will turn the motor in a way to prevent adding additional torque to the screw.

### Recording the Incidents of Exceeding the Maximum Limits of the Device:

Tools manufacturers in general design their tools to withstand the abuse, and they call it “rugged design”, which resulted in high cost. But in today's economy, with increasing competition, every one is struggling to reduce his cost and improve his quality. The way to do this is by designing the tools within a pre-specified reasonable range. It is expensive to design a torque wrench for a full scale of 0 to 100 Ft-Lb to be able to withstand 500 Ft-Lb. A new feature in my invention is the ability to permanently record if the tool was used out of its range of specifications (max. torque, max. temperature, etc.). In the example where the torque specification is 0 to 100 Ft-Lb, the design should handle up to 150 Ft-Lb. When the user exceeds certain percentage of the specified range (e.g. 130 Ft-Lb), the unit will not get damaged, but the electronics will permanently record this abuse. The manufacturer can use this record to waive his warranty, as a proof of his good design, and to protect his reputation.

To record the device abuse, the device compares each reading to a limiting value, when it exceeds the limit, the microcontroller will record this event in its permanent memory.

To do this recording while the unit is not powered, the unit could be powered by the microcontroller or by an electromechanical method (e.g. a switch at the displacement lever (71)). In case there is no power switch, the circuit could be designed in a way to leave the microcontroller in a sleeping mode most of the time, and the microcontroller wakes up and connects power on sensing a torque change, a torque exceeding certain limits, or a change of the status of any switch.

### External Interface and Communications with the Microcontroller:

Using few switches and a numerical 7-segment display is a good way to input the parameters and control the functions of the device in simple cases. To get more functionality of the device other user interfaces are used, examples are keypads, touch screens, alphanumeric displays, external programming devices, and serial or parallel communications. Serial communications with a powerful device like a personal computer (PC) or a microprocessor make a good user interface. One example to input the parameters to the torque device is to have a graphical user interface generated on a PC screen. The operator can fill the required parameters in an easy and friendly way, then the PC transfers them to the torque device using a serial port (or a USB port).

The embodiments shown represent the general cases, and eliminating or adding some components in the present invention without departing from the spirit and scope of the invention could generate various embodiments. Some examples are:
1. In the embodiments represented by FIG. 8, the device can have two switches only like (40) and (41), to do the functions of the four switches (40), (41), (43), and (45). For example, to set the maximum torque press the two switches (40) and (41) for about 5 seconds continuously, to reach the calibration mode press the two switches (40) and (41) for about 10 seconds continuously. To toggle the torque measurements to different units, press the switch (40) for about 2 seconds. To clear the readings (e.g. during maximum values collection) press the switch (41) for about 2 second. To toggle the displayed values between average, maximum, or others; press the switch (41) two times quickly within 2 seconds.
2. An LED could be added to flash when the torque reaches the set value, which could also blink at a rate proportional to the difference between the set and the read values.
3. In the embodiments of FIGS. 11 and 11a: the resistance with a wiper (as a sensor) could be replaced by a resistor with a curved contact strip like the one shown in FIG. 5.
4. In the embodiments where we have auto scaling and the torque sensor is an optical one, we can change the current drive for the LED, or use more than one LED. Similarly for the cases of magnetic sensor we can use more than one sensor or source.
5. The embodiments to read the torque in both directions as shown in FIGS. 11 and 11a, in which the zero torque corresponds to a reading close to half the scale, could be applied easily to the embodiments of FIGS. 3, 4, 6, 7, and others.
6. In FIGS. 5 and 5b, the resistor element (59) could be of a circular shape instead of the straight one, and the contact strip (75) could be circular (helical). The displacement spring (76) could be of any kind suitable to the function.
7. In the embodiments where the force sensor could be positioned at different distances from the center of the torque application, a distance-measuring sensor (217) (e.g. a simple linear potentiometer) could be used to generate an electronic signal indicating the position (distance). This output signal of the sensor is conditioned by the auxiliary conditioning circuit (218) and fed to the microcontroller to read it, and calculate the torque by multiplying the distance by the force. To add this feature to an embodiment like FIG. 8, a linear potentiometer could be mounted on the wrench (38) or inside the handle (47), such that the sliding contact of the potentiometer is coupled to the sensor (39) to be able to give an indication of the distance.
8. The embodiment of FIG. 15 could be for an air power wrench, by replacing the electric motor (92) by an air-motor with the addition of proper air valves and controls.
9. In many embodiments of the invention the ratchet device works in both directions (CW and CCW) using a change mechanism. This could be modified to work in one direction only (CW). To use it in the other direction (CCW) turn the ratchet around itself. This can simplify both the torque measurements and the ratchet mechanism.
10. A microcontroller that has the functions represented by separate blocks in FIG. 17 implemented inside it, could be used to simplify the design and the construction of the device (e.g. wireless transceiver, USB ports, serial ports, digital to analog converters, etc.).
11. Also, the torque device of this invention could be designed and implemented in different ways with certain features to meet the needs of regular consumers, handy men, machine shops, professionals, production lines, assembly lines, etc.

Thus the scope of the invention should be determined by the appended claims and their legal equivalents, rather than by the examples given.

What is claimed is:

1. A device for measuring the force applied to a structure comprising:
a) a force applying means;
b) a force sensor means for generating an electrical signal in response to said force applying means;
c) a processor means for controlling the functions of the device comprising: an information input means to introduce to said processor means setup and control parameters; a decoding means to decode said electrical signal into at least one recognizable indication of the force in one of a plurality of physical measuring units; and a calibration means to run calibration of the device when applying calibration forces; and
d) a means for indicating to an operator said recognizable indication.

2. The force-measuring device of claim 1 wherein; said information input means is a set of switches; said operator is a human operator; and said indicating means are: a numerical display, an announcing voice, an alarming sound, and flashing of the display when the measured force reaches or exceeds a preset value.

3. The force-measuring device of claim 1 wherein said operator is a machine and said information input means is a machine.

4. The force-measuring device of claim 1 wherein said electrical sensor means is a resistor element that its resistance changes a predetermined change in accordance with a predetermined force applied on it.

5. The force-measuring device of claim 1 wherein said electrical sensor means comprises: a spring; a curved contact strip; and a linear potentiometer.

6. The force-measuring device of claim 1 wherein said electrical sensor means comprises: a shell filled with hydraulic fluid; a piston with piston shaft; a spring; and a linear potentiometer.

7. The force-measuring device of claim 1 wherein said electrical sensor means comprises: a lever arm; a spring; a magnifying arm; and a linear potentiometer.

8. The force-measuring device of claim 1 wherein said electrical sensor means comprises: a lever arm; a spring; a displacement arm; a magnetic source; and a magnetic sensor.

9. The force-measuring device of claim 1 wherein said electrical sensor means comprises: a lever arm; a spring; a displacement arm; a light emitting source; a light aperture; and a light sensor.

10. A torque-measuring device to measure the torque applied to a workpiece comprising:
a) a torque applying means;
b) a tool means to apply the torque from said torque applying means to said workpiece;
c) a torque sensor means for generating an electrical signal in response to the torque of said torque applying means;
d) a processor means for controlling the functions of the device comprising: an information input means to introduce to said processor means setup and control parameters; a decoding means to decode said electrical signal into at least one recognizable indication of the torque in one of a plurality of physical measuring units; a calibration means with permanent recording, to run calibration of the device when applying calibration torques and permanently record calibration parameters; and an indicating and recording means to record and indicate to the operator when the torque reaches or exceeds certain predetermined values; and
e) a means for indicating to an operator said recognizable indication of the torque.

11. The torque-measuring device of claim 10 further comprising a head-angle varying means and a head-angle sensor means.

12. The torque-measuring device of claim 10 further comprising scale selection means, and wherein said tool means has an attaching means to attach and detach different tools to said torque applying means.

13. The torque-measuring device of claim 10 wherein said torque applying means comprises: a drive shaft; a clutch coupling means to controllably couple said drive shaft to said driven shaft; and a driven shaft to drive said tool means.

14. The torque-measuring device of claim 10 wherein said operator is a machine and said information input means is a machine.

15. The torque-measuring device of claim 11 wherein said torque sensor means is a resistor element that its resistance changes a predetermined change in accordance with a predetermined force applied on it.

16. The torque-measuring device of claim 11 wherein said torque sensor means comprises: a lever arm; a spring; a curved contact strip; and a linear potentiometer.

17. The torque-measuring device of claim 10 wherein said torque applying means is a power drive.

18. A method for measuring and calibrating the torque applied to a workpiece, comprising:
a) providing a body which is able to exert a torque on a work piece when applying a force at a point on said body at a suitable distance from said workpiece,
b) providing a force sensor which is able to generate an electrical signal proportional to the applied force,
c) providing a central processing means capable of performing preprogrammed functions,
d) providing a permanent memory which is able to store enough information for said central processing means,
e) providing a set of parameters to control the functions of the device,
f) providing an information output means to convey the measurements to an operator,
g) providing an information input means to enter the setup parameters to said central processing means, and
h) providing a calibration means to calibrate the measurement method and store calibration parameters in the permanent memory of said central processing means.

19. The method for measuring and calibrating the torque applied to a workpiece of claim 18, wherein said self calibration means comprises the following steps:
a) applying an accurate torque to the device,
b) entering a calibration mode of the device,
c) providing an indication of the calibration mode,
d) entering the value of the applied calibration torque,
e) getting a large number of readings for said applied torque,
f) checking the readings to validate the functionality of the sensor and the torque,
g) calculating and storing new parameters for measuring the torque,
h) displaying the result of each calibration,
i) repeating the calibration steps as needed, and
j) exiting the calibration mode.

20. The method for measuring and calibrating the torque applied to a workpiece of claim 18, further providing: detecting, indicating, and recording means to permanently record the incidents of abuse.
